(19) United States
(12) Patent Application Publication
(10) Pub. No.: US 2003/0202456 A1
(43) Pub. Date: Oct. 30, 2003

(54) Apparatus and method for reproducing data using capacitance variation

(75) Inventors: Seung-bum Hong, Kyungki-do (KR); Hyun-Jung Shin, Kyungki-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 10/294,605

(22) Filed: Nov. 15, 2002

(30) Foreign Application Priority Data
Apr. 25, 2002 (KR) 2002-22705

(51) Int. Cl. G11B 9/00

(52) U.S. Cl. 369/126

(57) ABSTRACT

Provided are an apparatus and a method for reproducing data using capacitance. The apparatus includes a tip, a cantilever, a positioning portion, a power supply, an electrostatic force measuring portion, and a controller. The tip contacts a recording medium on which data is recorded by a bit. The cantilever is made of conductive material and has a free end for supporting the tip. The positioning portion moves the cantilever so as to determine a position of the tip on the recording medium. The power supply is connected between the recording medium and the cantilever in order to apply a voltage to the recording medium and the cantilever so as to generate an electrostatic force therebetween. The electrostatic force measuring portion measures the electrostatic force generated between the recording medium and the cantilever. The controller determines a local capacitance of the recording medium from the electrostatic force measured by the electrostatic force measuring portion. In the method, the tip, which is supported by a free end of the conductive cantilever, contacts a predetermined position of the recording medium to reproduce data therefrom. While the tip contacts the recording medium, a voltage is applied to the tip and the recording medium in order to generate an electrostatic force therebetween. The generated electrostatic force is measured, and then the capacitance in the predetermined position of the recording medium is determined from the measured electrostatic force. Data recorded on the recording medium is reproduced according to magnitude of the determined capacitance.

### BACKGROUND OF THE INVENTION

This application claims the priority of Korean Patent Application No. 2002-22705, filed Apr. 25, 2002 in the Korean Intellectual Property Office, the disclosure of which is incorporated herein in its entirety by reference.

1. Field of the Invention

The present invention relates to an apparatus and a method for reproducing data from a recording medium, and more particularly, to an apparatus and a method for reproducing data from a recording medium on which high-density data is stored, by using a microprobe tip.

2. Description of the Related Art

As the demand for compact products such as personal communication systems (PCSs), electronic organizers, etc., increases, the necessity for subminiature high-density nonvolatile recording media also increases. As is well known, it is not easy to make existing hard disks compact-sized and to highly integrate flash memory. Alternatively, researches on recording media using scanning probes have been carried out. Here, the scanning probes are microprobes, which are used in a scanning probe microscope (SPM), such as a scanning transmission microscope (STM) or an atomic force microscope (AFM).

Recording media used as data storing apparatuses using microprobes has recording density of hundreds of Gbits/in², much higher than that of existing hard disks. Thus, the recording media may be widely used in apparatuses, such as substitute apparatuses for hard disk drives (HDDs), digital cameras, mobile telecommunication equipment, portable equipment, or the like.

A method of reproducing data by using scanning probes includes a method of sensing an electrostatic force, a static magnetic force, a piezoelectric force, etc., acting in the scanning probes, a method of sensing differences in electric conductivity or thermal conductivity, or the like. In particular, there has been disclosed a method of heating a scanning probe at a high temperature of 300 C. or more, adjusting a distance between a cantilever and a recording medium, and sensing differences in the amount of heat emitted from the cantilever to the air was disclosed in IBM J. res. develop. Vol. 44, No. 3, May 2000. In this method, since it is determined whether the scanning probe goes into a bit by using a difference in the amount of heat emission, temperature is required to be minutely adjusted. Also, since a speed of emitting heat is slower than a sensing velocity of an existing electronic sensor, a high-priced thermostat is needed to monitor variations in a temperature of a register which is continuously heated. Therefore, manufacturing costs of an apparatus for reproducing data increase and power consumption there of is large.

### SUMMARY OF THE INVENTION

To solve the above-described problems, it is a first object of the present invention to provide an apparatus, having a simple and low-priced structure, which is capable of reproducing data from a high-density recording medium.

It is a second object of the present invention to provide a method for reproducing data by which a reproducing velocity can be remarkably increased by a simple method.

Accordingly, to achieve the first object, there is provided an apparatus for reproducing data. The apparatus includes a tip, a cantilever, a positioning portion, a power supply, an electrostatic force measuring portion, and a controller. The tip contacts a recording medium on which data is recorded by a bit. The cantilever is made of conductive material and has a free end for supporting the tip. The positioning portion moves the cantilever so as to determine a position of the tip on the recording medium. The power supply is connected between the recording medium and the cantilever in order to apply a voltage to the recording medium and the cantilever so as to generate an electrostatic force therebetween. The electrostatic force measuring portion measures the electrostatic force generated between the recording medium and the cantilever. The controller determines a local capacitance of the recording medium from the electrostatic force measured by the electrostatic force measuring portion.

The recording medium includes an electrode layer and a polymer thin film formed on the electrode layer.

The cantilever is formed of high-doped silicon, and the tip is formed of low-doped silicon. Also, the tip is a conic tip, a pyramidal tip, or a cylindrical tip and has a radius of 50 nm or less.

To achieve the second object, there is provided a method of reproducing data. A tip supported by a free end of a conductive cantilever contacts a predetermined position of a recording medium. A voltage is applied to the tip and the recording medium to generate an electrostatic force therebetween while the tip contacts the recording medium. The electrostatic force generated by the voltage applied to the tip and recording medium is measured. A capacitance in the predetermined position of the recording medium is determined from the measured electrostatic force. Data recorded on the recording medium is reproduced according to magnitude of the determined capacitance.

The recording medium includes an electrode layer, a polymer thin film formed on the electrode layer, and data recorded by a bit indentation of a surface of the polymer thin film to a predetermined depth.

In the method according to the present invention, the cantilever is placed in a first position in which the tip contacts the surface of the polymer thin film of the recording medium. A first capacitance is determined from an electrostatic force generated in the fist position. The cantilever is placed in a second position in which the tip contacts bottom of the bit of the recording medium. A second capacitance is determined from an electrostatic force generated in the second position. The first and second capacitances are compared to sense an increase or a decrease in the capacitance.

A data reproducing apparatus according to the present invention does not require high-priced equipment, such as a thermostat, etc. Thus, it is simple to constitute the data reproducing apparatus, costs for manufacturing the data reproducing apparatus can be lowered, and power consumption of the apparatus can be considerably reduced. Also, since the data reproducing apparatus according to the present invention has a fast response characteristic and high resolution, a reproducing velocity can be remarkably increased

### BRIEF DESCRIPTION OF THE DRAWINGS

The above objects and advantages of the present invention will become more apparent by describing in detail preferred embodiments thereof with reference to the attached drawings in which:

FIG. 1 is a schematic view of essential parts of a data reproducing apparatus according to a preferred embodiment of the present invention;

FIGS. 2 and 3 are cross-sectional views for explaining variations in capacitance according to a relative distance between a cantilever and a recording medium in the data reproducing apparatus according to a preferred embodiment of the present invention;

FIG. 4A is a scanning electron microscope (SEM) photograph of a Si lattice used as an experimental recording medium sample to verify the basic principle of the present invention;

FIG. 4B is a partial perspective view of a structure of the experimental recording medium sample shown in FIG. 4A;

FIGS. 5A and 5B are topography and electrostatic force microscopy (EFM) image, respectively, observed by scanning recording medium samples, each having a step height Hs of 500 nm, along y-axis with an atomic force microscope (AFM);

FIGS. 6A and 6B are topography and EFM image, respectively, observed by scanning recording medium samples, each having a step height Hs of 100 nm, along y-axis with an AFM;

FIGS. 7A and 7B are topography and EFM image, respectively, observed by scanning recording medium samples, each having a step height Hs of 50 nm, along y-axis with an AFM;

FIGS. 8 and 9 are graphs illustrating line profiles quantitatively representing topography and EFM image, respectively, observed by scanning recording medium samples, each having a step height Hs of 500 nm, along y-axis with an AFM; and

FIG. 10 is a flowchart explaining a method for reproducing data according to the preferred embodiment of the present invention.

### DETAILED DESCRIPTION OF THE INVENTION

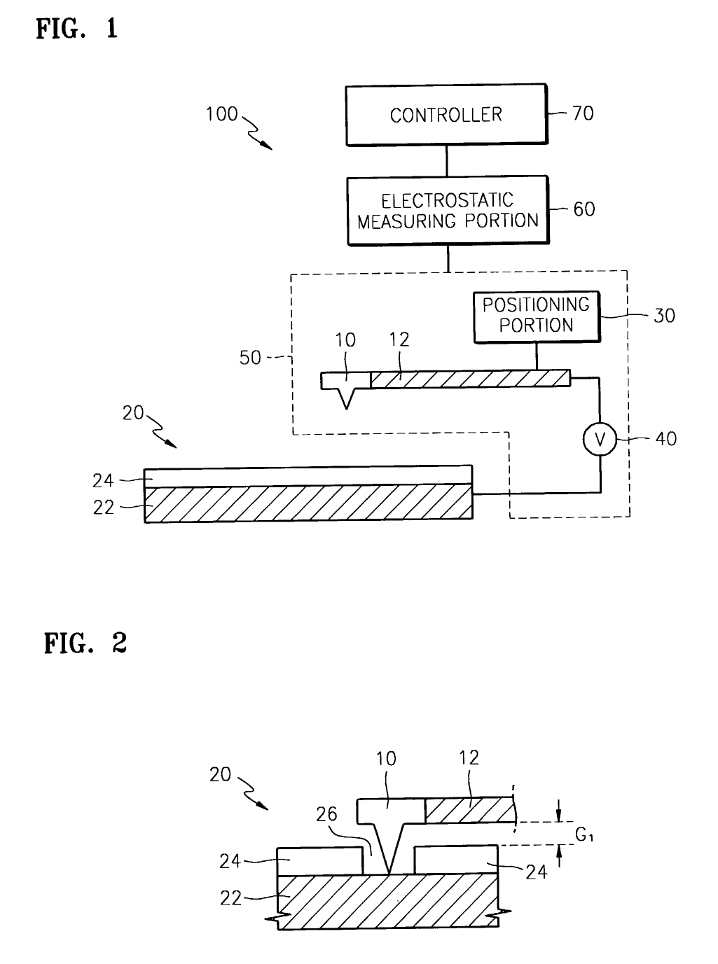

FIG. 1 is a schematic cross-sectional view of essential parts of a data reproducing apparatus according to a preferred embodiment of the present invention. Referring to FIG. 1, a data reproducing apparatus 100 includes a tip 10 which contacts a recording medium 20 in order to reproduce data from the recording medium 20, and a cantilever 12, which is made of conductive material and which has a free end for supporting the tip 10. The cantilever 12 is supported by a cantilever support (not shown) which is connected to a positioning portion 30 composed of x, y, and z canners. The positioning portion 30 may determine a position of the tip 10 on the recording medium 20. The above-described structure may also be realized using a well-known atomic force microscope 50.

The tip 10 is made of low-doped silicon, and may be a conic probe, a pyramidal probe, or a cylindrical probe having a radius of about 50 nm or less.

The cantilever 12 is made of high-doped silicon so as to have conductivity.

The recording medium 20 includes an electrode layer 22 made of silicon and a polymer thin film 24 formed on the electrode layer 22. The polymer thin film 24 may be formed of polymethylmethacrylate (PMMA) and may have a thickness of about 40 nm. Data is recorded on the recording medium 20 by a bit indentation (hereinafter referred to as a bit) formed in the surface of the polymer thin film 20.

The cantilever 12 and the recording medium 20 may be supplied with a voltage by a power supply 40 which is connected between the cantilever 12 and the recording medium 20. When the power supply 40 applies a voltage to the cantilever 12 and the recording medium 20 while the tip 12 contacts a predetermined position of the recording medium 20, an electrostatic force is generated therebetween. The electrostatic force measuring portion 60 measures the generated electrostatic force. A controller 70 determines a local capacitance of the predetermined position of the recording medium 20 from the measured electrostatic force.

In more detail, when the power supply 40 supplies the voltage to the cantilever 12 and the recording medium 20, the cantilever 12 and the recording medium 20 serve as a parallel plate capacitor. In other words, the cantilever 12 operates as one plate constituting a capacitor, and the recording medium 20 operates as the other plate constituting the capacitor. An electrostatic force Fₑ generated by the voltage applied to the cantilever 12 and the recording medium 20 is given by Equation 1:

$${F}_{e} = \frac{1}{2} \frac{ⅆ C}{ⅆ x} {V}^{2} \qquad ( 1 )$$

wherein, dC/dx denotes a capacitance gradient between the cantilever 12 and the recording medium 20 according to variations in a distance x between the cantilever 12 and recording medium 20, and V denotes the applied voltage.

In Equation 1, an increase or a decrease in capacitance can be sensed from the electrostatic force Fₑ generated between the cantilever 12 and the recording medium 20.

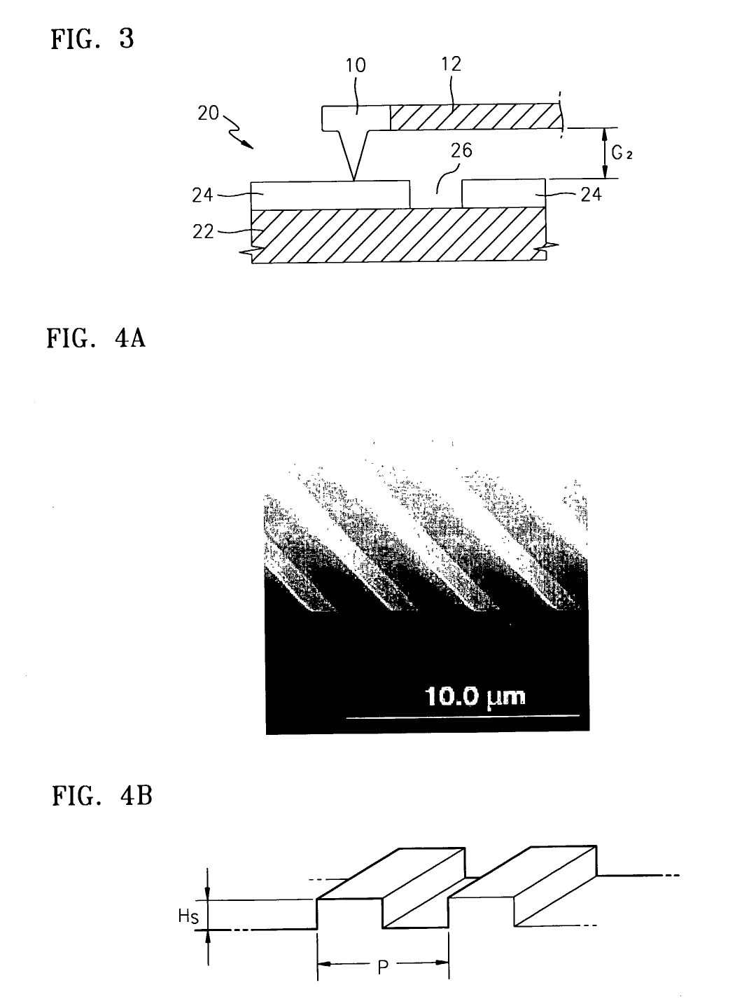

FIGS. 2 and 3 are cross-sectional views for explaining variations in a capacitance according to a relative distance between the cantilever 12 and the recording medium 20.

As shown in FIG. 2, when the tip 10 connected to the free end of the cantilever 12 is put into a bit 26 formed in the recording medium 20 to contact the recording medium 20, a distance G₁ between the cantilever 12 and the recording medium 20 is relatively small. In contrast, as shown in FIG. 3, when the tip 10 connected to the free end of the cantilever 12 is placed on the polymer thin film 24 of the recording medium 20 in which the bit 26 is not formed, a distance G₂ between the cantilever 12 and the recording medium 20 is relatively large.

In other words, the distance between the cantilever 12 and the recording medium 20 decreases when the tip 10 is put into the bit 26 of the recording medium 20, while the distance between the cantilever 12 and the recording medium 20 increases when the tip 10 is not positioned in the bit 26. Thus, the capacitance between the cantilever 12 and the recording medium 20 increases or decreases depending on whether the tip 10 is put into the bit 26. By measuring variations in capacitance, a state “1”, representing a state when the tip 10 is put into the bit 26, can be distinguished from a state “0”, representing a state when the tip 10 comes out of the bit 26.

FIG. 4A is a scanning electron microscope (SEM) photograph of a Si lattice used as an experimental recording medium sample to verify the basic principle of the present invention, and FIG. 4B is a partial perspective view of a structure of the experimental recording medium sample shown in FIG. 4A.

Three kinds of Si lattice samples, which are coated with a SiOx thin film and each of which has repetitive line patterns of step heights Hs of 500 nm, 100 nm, and 50 nm, respectively, were used as the experimental recording medium samples. A sample shown in FIG. 4A has a step height Hs of 100 nm. A pitch P of the step induced by the patterns of the sample was about 3 m.

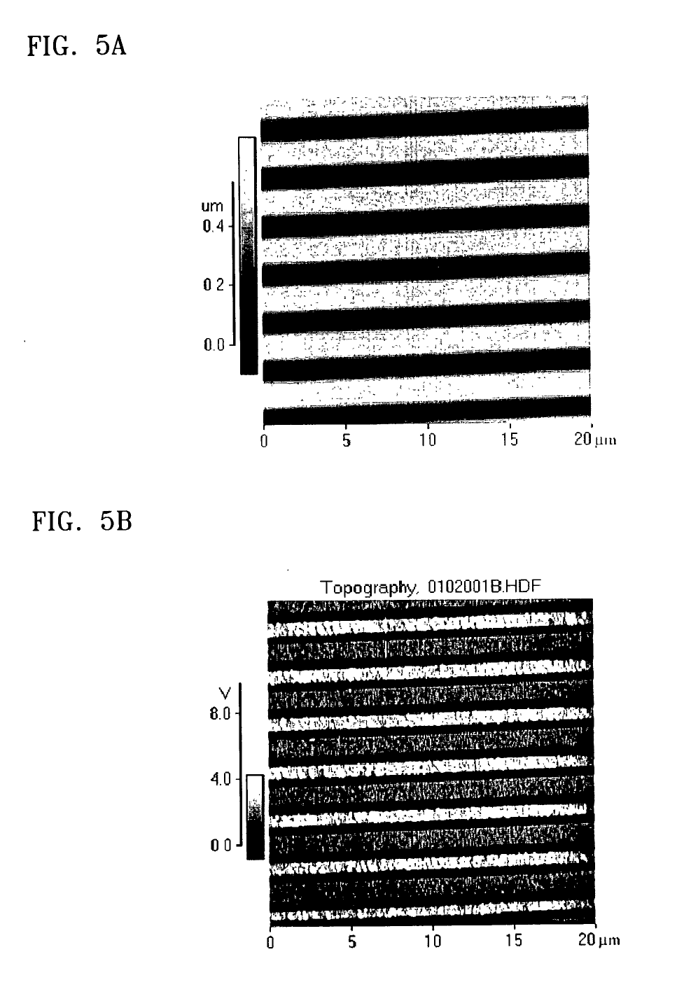

FIGS. 5A and 5B show topography and electrostatic force microscopy (EFM) image, respectively, observed by scanning recording medium samples, each having a step height Hs of 500 nm, along y-axis with an AFM.

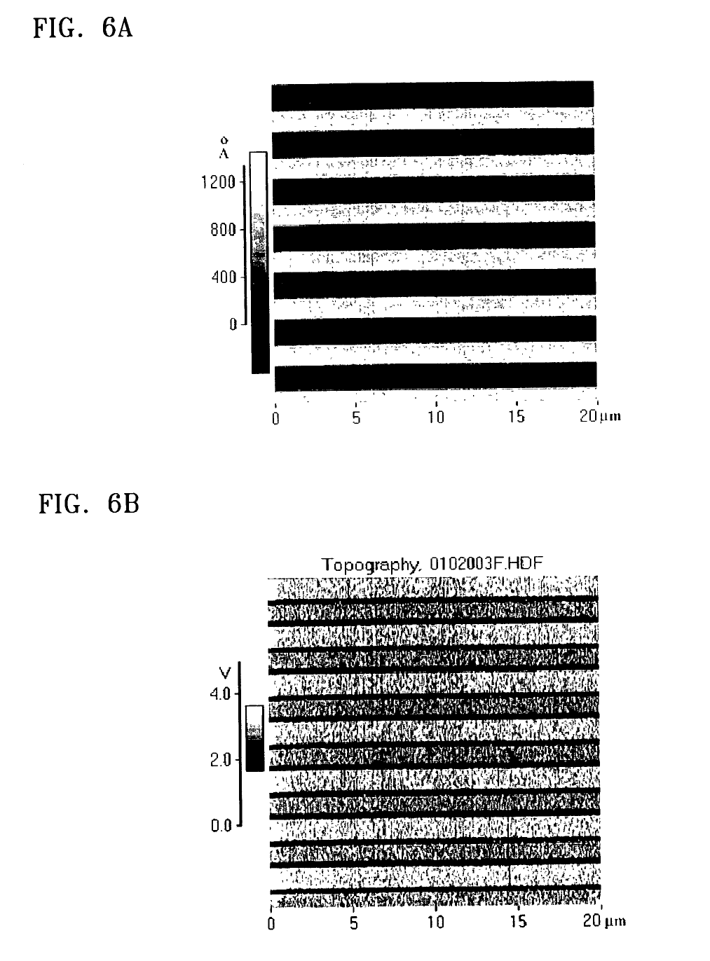

FIGS. 6A and 6B show topography and electrostatic force microscopy (EFM) image, respectively, observed by scanning recording medium samples, each having a step height Hs of 100 nm, along y-axis with an AFM.

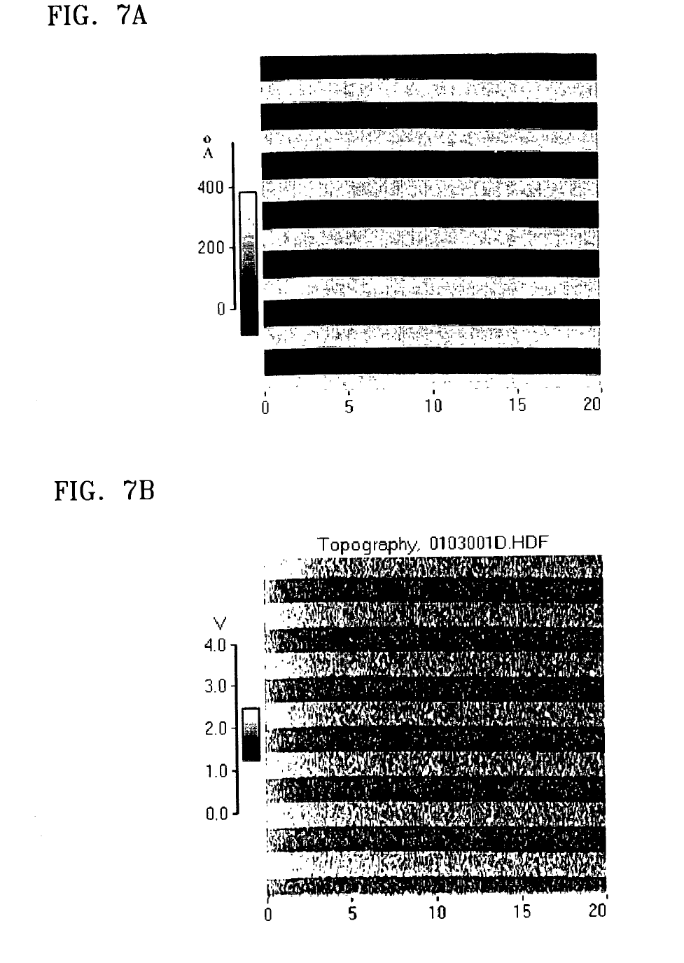

FIGS. 7A and 7B show topography and electrostatic force microscopy (EFM) image, respectively, observed by scanning recording medium samples, each having a step height Hs of 50 nm, along y-axis with an AFM.

As seen in FIGS. 5A, 5B, 6A, 6B, 7A, and 7B, when a tip is put into a pit formed between patterns forming a step of a recording medium, the capacitance increases. Relatively bright portions in EFM images reflect the increased capacitance. While, relatively dark portions of the EFM images reflect when the tip contacts a land that is an upper surface of the pattern.

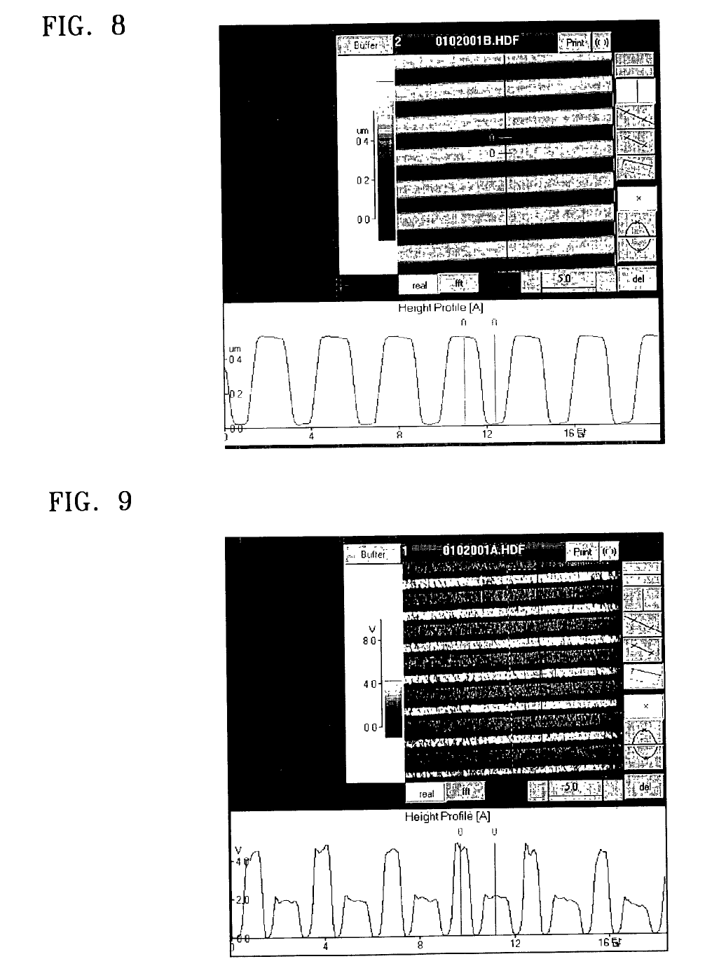

FIGS. 8 and 9 are graphs illustrating line profiles quantitatively showing topography and EFM image, respectively, observed by scanning recording medium samples, each having a step height Hs of 500 nm, along y-axis with an AFM.

The line profiles shown in FIGS. 8 and 9 show variations in the capacitance along an arrow x direction from the topography and EFM image. In FIGS. 8 and 9, it can be seen that indents and protrusions of the topography correspond to high and low capacitances, respectively.

A method of reproducing data from a high-density recording medium will be now described with reference to the above-verified basic principle of the present invention.

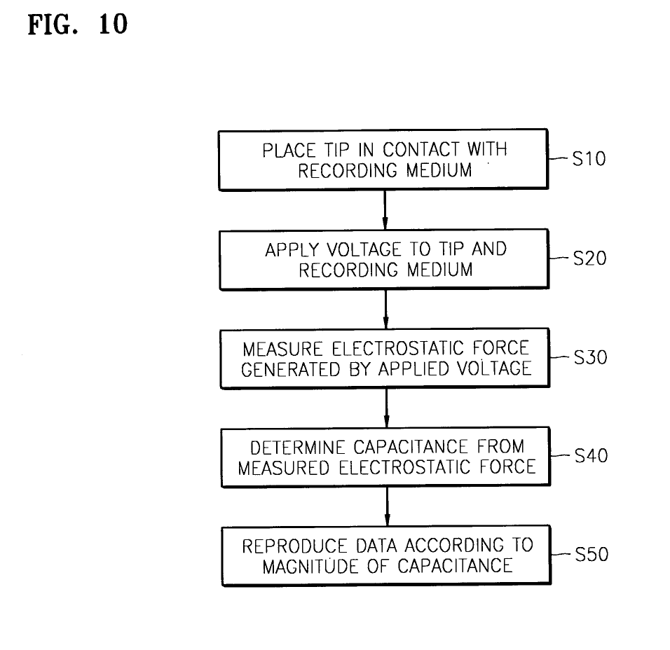

FIG. 10 is a flowchart for explaining a method of reproducing data according to a preferred embodiment of the present invention. Referring to FIGS. 1 and 10, in step S10, the tip 10, which is supported by the free end of the cantilever 12, is placed so as to contact a predetermined position of the recording medium 20. In step S20, while the tip 10 contacts the recording medium 20, the power supply 40 supplies a voltage to the tip 10 and the recording medium 20 to generate an electrostatic force therebetween. In step S30, the electrostatic force measuring portion 60 measures the electrostatic force generated by the voltage applied to the tip 10 and the recording medium 20. In step S40, the controller 70 determines capacitance of the predetermined position of the recording medium 20 from the electrostatic force measured by the electrostatic force measuring portion 60. In step S50, data recorded on the recording medium 20 is reproduced according to magnitude of the determined capacitance.

In the above-described data reproducing method according to the present invention, in order to reproduce data recorded on the recording medium 20 using the bit 26, the cantilever 12 is located in a first position in which the tip 10 contacts the surface of the polymer thin film 24 of the recording medium 20, and then first capacitance is determined from an electrostatic force generated in the first position. Also, the cantilever 12 is located in a second position in which the tip 10 is placed on the bottom of the bit 26 of the recording medium 20, and then second capacitance is determined from an electrostatic force generated in the second position. An increase or a decrease in capacitance is sensed by comparing the first and second capacitances.

In a data reproducing method according to the present invention, a voltage is applied to a cantilever supporting a tip and a recording medium to sense a bit formed in a high-density recording medium. Thereafter, an increase or a decrease in capacitance is sensed from an electrostatic force generated between the cantilever and the recording medium so as to reproduce data from the high-density recording medium.

A data reproducing apparatus according to the present invention does not require high-priced equipment, such as a thermostat, etc., compared with a conventional data reproducing apparatus using a thermal reproducing method or a pressure reproducing method. Thus, it is simple to constitute the data reproducing apparatus, costs for manufacturing the data reproducing apparatus can be lowered, and power consumption of the apparatus can be considerably reduced. Also, since the data reproducing apparatus according to the present invention has a fast response characteristic and high resolution, a reproducing velocity can be remarkably increased. Further, according to the data reproducing method of the present invention, in case of a conductive sample or a regularly-arranged pattern, the shape of the surface of the sample can be observed without using a high-priced optical system which is installed to measure displacements of a probe of an AFM.

While this invention has been particularly shown and described with reference to a preferred embodiment thereof, it will be understood by those skilled in the art that various changes in form and details may be made therein without departing from the spirit and scope of the invention as defined by the appended claims and equivalents thereof.

What is claimed is:

1. An apparatus for reproducing data, the apparatus comprising:
a tip which contacts a recording medium on which data is recorded by a bit;
a cantilever which is made of conductive material and has a free end for supporting the tip;
a positioning portion which moves the cantilever so as to determine a position of the tip on the recording medium;
a power supply which is connected between the recording medium and the cantilever in order to apply a voltage to the recording medium and the cantilever so as to generate an electrostatic force therebetween;
an electrostatic force measuring portion which measures the electrostatic force generated between the recording medium and the cantilever; and
a controller which determines a local capacitance of the recording medium from the electrostatic force measured by the electrostatic force measuring portion.

2. The apparatus of claim 1, wherein the recording medium comprises an electrode layer and a polymer thin film formed on the electrode layer.

3. The apparatus of claim 1, wherein the cantilever is formed of high-doped silicon.

4. The apparatus of claim 1, wherein the tip is formed of low-doped silicon.

5. The apparatus of claim 1, wherein the tip is one of a conic tip, a pyramidal tip, and a cylindrical tip.

6. The apparatus of claim 1, wherein the tip has a radius of 50 nm or less.

7. A method of reproducing data, the method comprising:
placing a tip supported by a free end of a conductive cantilever so as to contact a predetermined position of a recording medium;
applying a voltage to the tip and the recording medium to generate an electrostatic force therebetween while the tip contacts the recording medium;
measuring the electrostatic force generated by the voltage applied to the tip and recording medium;
determining a capacitance in the predetermined position of the recording medium from the measured electrostatic force; and
reproducing data recorded on the recording medium according to magnitude of the determined capacitance.

8. The method of claim 7, wherein the recording medium comprises an electrode layer, a polymer thin film formed on the electrode layer, and data recorded by a bit indentation of a surface of the polymer thin film to a predetermined depth.

9. The method of claim 8, further comprising:
placing the cantilever in a first position in which the tip contacts the surface of the polymer thin film of the recording medium;
determining a first capacitance from an electrostatic force generated in the fist position;
placing the cantilever in a second position in which the tip contacts bottom of the bit of the recording medium;
determining a second capacitance from an electrostatic force generated in the second position; and
comparing the first and second capacitances to sense an increase or a decrease in the capacitance.

10. The method of claim 7, wherein the cantilever is formed of high-doped silicon.

11. The method of claim 9, wherein the cantilever is formed of high-doped silicon.

12. The method of claim 7, wherein the tip is formed of low-doped silicon.

13. The method of claim 9, wherein the tip is formed of low-doped silicon.
